(19) United States
(12) Patent Application Publication
(10) Pub. No.: US 2022/0360684 A1
(43) Pub. Date: Nov. 10, 2022

(54) IMAGE PROCESSING SYSTEM INCLUDING PLURALITY OF IMAGE FORMING APPARATUSES THAT SHARE APPARATUS STATE INFORMATION OF EACH IMAGE FORMING APPARATUS AND INFORMATION PROCESSING APPARATUS THAT ACQUIRES APPARATUS STATE INFORMATION TO BE DISPLAYED ON DISPLAY DEVICE

(71) Applicant: KYOCERA Document Solutions Inc., Osaka (JP)

(72) Inventors: Wataru TSUKUDA, Osaka (JP); Yuya TAGAMI, Osaka (JP)

(73) Assignee: KYOCERA Document Solutions Inc., Osaka (JP)

(21) Appl. No.: 17/721,832

(22) Filed: Apr. 15, 2022

(30) Foreign Application Priority Data
May 7, 2021 (JP) 2021-079272

(51) Int. Cl. H04N 1/32; H04N 1/00

(52) U.S. Cl. CPC H04N 1/32539; H04N 1/00347; H04N 2201/0094; H04N 2201/0039; H04N 2201/0072

(57) ABSTRACT

The first controller of the image forming apparatus transmits first apparatus state information of the own image forming apparatus to the other image forming apparatus, and when second apparatus state information of the other image forming apparatus is received, stores the second apparatus state information in the storage device. The second controller of the information processing apparatus transmits an information collecting request to the image forming apparatus. When the information collecting request is received, the first controller transmits the first and second apparatus state information to the information processing apparatus. When the first and second apparatus state information are received, the second controller displays positions, functions, and power on states or off states of the own image forming apparatus and the other image forming apparatus indicated by the first and second apparatus state information on the display device.

### INCORPORATION BY REFERENCE

This application claims priority to Japanese Patent Application No. 2021-079272 filed on 7 May, 2021, the entire contents of which are incorporated by reference herein.

### BACKGROUND

The present disclosure relates to an image processing system including a plurality of image forming apparatuses that perform data communication with each other and an information processing apparatus that performs data communication with each image forming apparatus.

For an image processing system, for example, the following general first and second techniques are known.

In the first technique, an automatic printer selection apparatus is provided on a network connecting a plurality of terminal apparatuses to a plurality of printers. The automatic printer selection apparatus manages operation information indicating an operation state of each printer, and also manages position information indicating a positional relationship between the terminal apparatus and each printer for each terminal apparatus, and determines a printer for printing data for which there is an output instruction from the terminal apparatus on the basis of the operation information and the position information. Consequently, a printer that is not in an operation state and has a short distance from the terminal apparatus can be automatically selected to perform printing.

In the second technique, a client terminal apparatus and a management server terminal apparatus are connected via a network. The client terminal apparatus creates device search request data according to a network protocol, transmits the device search request data to the management server terminal apparatus, and displays device information indicating a search result returned from the management server terminal apparatus. The device information is a device name, a product name, a network address, or a distance of a device terminal apparatus such as a printer or a copier, or geographical location data of the device terminal apparatus. Consequently, it is possible to present a device terminal apparatus that is convenient in terms of distance to a user.

### SUMMARY

As one aspect of the present disclosure, a technique for further improving the above technique is proposed.

According to an aspect of the present disclosure, there is provided an image processing system including a plurality of image forming apparatuses and an information processing apparatus. The plurality of image forming apparatuses perform data communication with each other. The information processing apparatus performs data communication with each of the plurality of image forming apparatuses. Each of the plurality of image forming apparatuses includes a storage device, a first communication device, and a first controller. The first communication device performs data communication with the other image forming apparatus other than an own image forming apparatus among the plurality of image forming apparatuses and the information processing apparatus via a network. The first control device includes a processor, and, by the processor executing a control program, functions as a first controller that transmits first apparatus state information indicating a position, a function, and a power on state or off state of the own image forming apparatus to the other image forming apparatus via the first communication device, and when second apparatus state information indicating a position, a function, and a power on state or off state of the other image forming apparatus is received from the other image forming apparatus via the first communication device, stores the second apparatus state information in the storage device. The information processing apparatus includes a display device, a second communication device, and a second controller. The second communication device performs data communication with each of the plurality of image forming apparatuses via the network. The second control device includes a processor and, by the processor executing a control program, functions as a second controller that transmits an information collecting request to at least one of the plurality of image forming apparatuses via the second communication device. When the information collecting request is received via the first communication device, the first controller of the image forming apparatus transmits the first apparatus state information and the second apparatus state information read from the storage device to the information processing apparatus via the first communication device. When the first apparatus state information and the second apparatus state information are received via the second communication device, the second controller of the information processing apparatus displays the positions, the functions, and the power on states or off states of the own image forming apparatus and the other image forming apparatus indicated by the first apparatus state information and the second apparatus state information on the display device.

### BRIEF DESCRIPTION OF THE DRAWINGS

FIG. 1 is a diagram showing a configuration of an image processing system according to a first embodiment of the present disclosure.

FIG. 2 is a block diagram showing a main configuration of an image forming apparatus.

FIG. 3 is a block diagram showing a main configuration of an information processing apparatus.

FIG. 4 is a flowchart showing a control procedure of an information sharing process according to the first embodiment.

FIG. 5 is a diagram showing coordinates of each Wi-Fi access point in an xy coordinate system.

FIG. 6 is a diagram conceptually showing an access point table.

FIG. 7 is a diagram conceptually showing a device table.

FIG. 8 is a flowchart showing a control procedure of a state display process according to the first embodiment.

FIG. 9 is a diagram showing an example of an image displayed on a screen of a display device of the information processing apparatus.

FIG. 10 is a diagram showing another example of an image displayed on the screen of the display device of the information processing apparatus.

FIG. 11 is a flowchart showing a control procedure of an information sharing process according to a second embodiment.

### DETAILED DESCRIPTION

Hereinafter, an image processing system according to first and second embodiments of the present disclosure will be described with reference to the drawings.

### First Embodiment

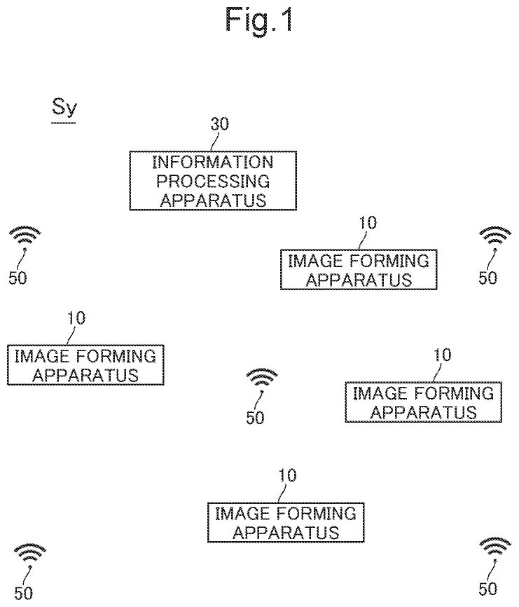

FIG. 1 is a diagram showing a configuration of an image processing system according to a first embodiment of the present disclosure. An image processing system Sy of the first embodiment includes a plurality of image forming apparatuses 10 and an information processing apparatus 30.

A plurality of Wi-Fi (registered trademark) access points 50 perform Wi-Fi communication with the image forming apparatus 10 or the information processing apparatus 30. Each image forming apparatus 10 transmits and receives data to and from another apparatus 10 via the Wi-Fi access point 50. The information processing apparatus 30 transmits and receives data to and from at least one of all the image forming apparatuses 10 (preferably all the image forming apparatuses 10) via the Wi-Fi access point 50.

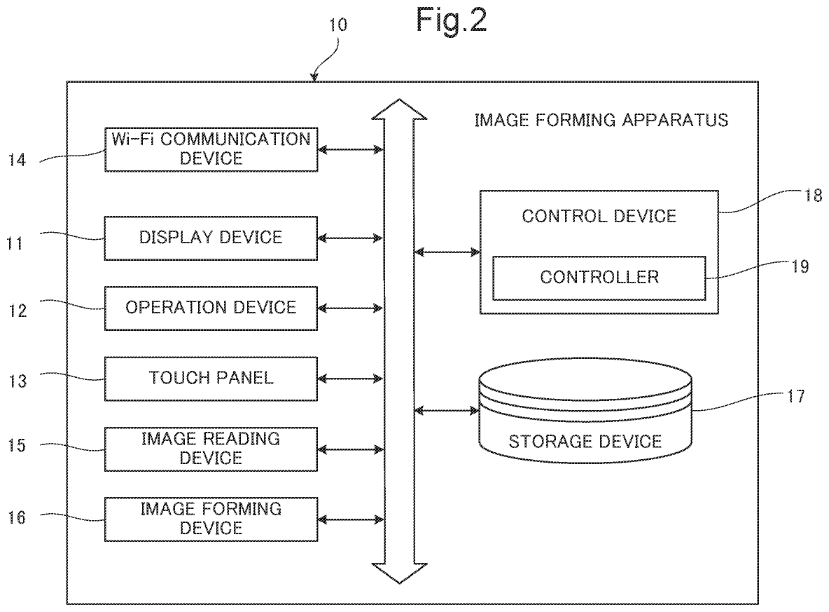

FIG. 2 is a block diagram showing a main configuration of the image forming apparatus 10. The image forming apparatus 10 is a multi-function peripheral (MFP) having a plurality of functions such as a copy function, a printer function, and a scanner function. The image forming apparatus 10 includes a display device 11, an operation device 12, a Wi-Fi communication device 14, a touch panel 13, an image reading device 15, an image forming device 16, a storage device 17, a control device 18, and the like. These constituents can transmit and receive data or signals to and from each other via a bus.

The display device 11 is configured with a liquid crystal display (LCD), an organic EL (OLED: Organic Light-Emitting Diode) display, or the like.

The touch panel 13 overlaps a screen of the display device 11. The touch panel 13 detects a contact (touch) of a user's finger or the like on the touch panel 13 together with a contact position, and outputs a detection signal indicating coordinates of the contact position to a controller 19 of the control device 18. Consequently, it is possible to operate a graphical user interface (GUI) or the like displayed on the screen of the display device 11 via the touch panel 13.

The operation device 12 includes a hard key such as a numeric keypad, an enter key, or a start key.

The image reading device 15 has a scanner that optically reads an image of an original placed on a contact glass. The image reading device 15 generates image data indicating the image of the original.

The image forming device 16 includes a photoconductor drum, a charging device that uniformly charges a surface of the photoconductor drum, an exposure device that exposes the surface of the photoconductor drum to form an electrostatic latent image on the surface of the photoconductor drum, a developing device that develops the electrostatic latent image on the surface of the photoconductor into a toner image, a transfer device that transfers the toner image (image) on the surface of the photoconductor drum onto recording paper as a recording medium, and the like. The image forming device 16 prints an image indicated by the image data on recording paper.

The Wi-Fi communication device 14 is a communication interface that performs Wi-Fi communication. The Wi-Fi communication device 14 transmits and receives data to and from the Wi-Fi access point 50.

The storage device 17 is a large-capacity storage device such as a solid state drive (SSD) or a hard disk drive (HDD). The storage device 17 stores various application programs and various types of data.

The control device 18 is configured with a processor, a random access memory (RAM), a read only memory (ROM), and the like. The processor is, for example, a central processing unit (CPU), an application specific integrated circuit (ASIC), or a micro processing unit (MPU). The control device 18 functions as the controller 19 when a control program stored in the ROM or the storage device 17 is executed by the processor.

The controller 19 performs overall control of the image forming apparatus 10. The control device 18 is connected to the display device 11, the operation device 12, the touch panel 13, the Wi-Fi communication device 14, the image reading device 15, the image forming device 16, the storage device 17, and the like. The controller 19 controls each of the above constituents and transmits and receives a signal or data to and from each constituent.

The controller 19 functions as a processor that executes various processes. The controller 19 has a function of controlling the display device 11 and the Wi-Fi communication device 14.

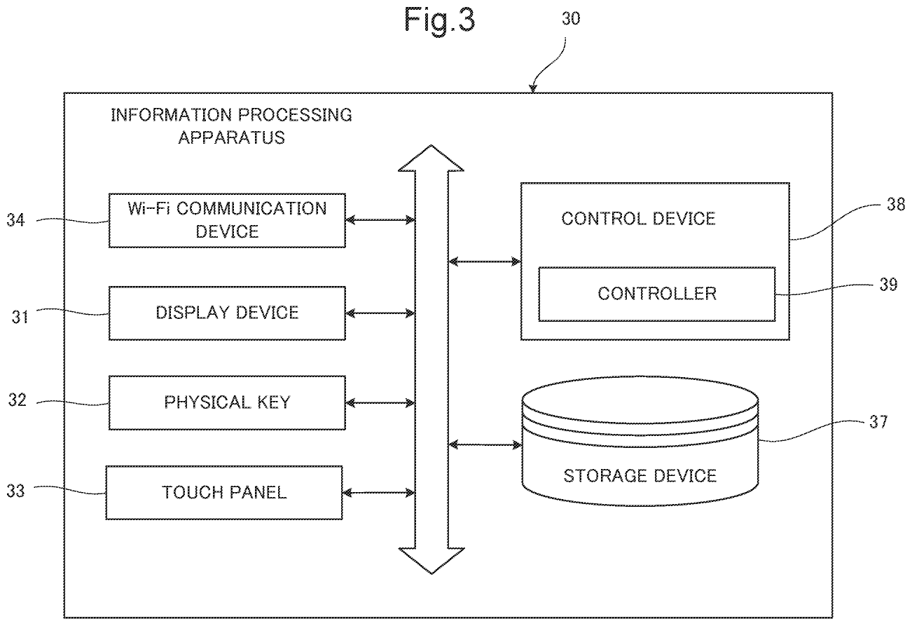

FIG. 3 is a block diagram showing a main configuration of the information processing apparatus 30. The information processing apparatus 30 is, for example, a portable smartphone or a mobile apparatus. The information processing apparatus 30 includes a display device 31, a physical key 32, a touch panel 33, a Wi-Fi communication device 34, a storage device 37, and a control device 38. These constituents can transmit and receive data or signals to and from each other via a bus.

The display device 31 is configured with a liquid crystal display, an organic EL, or the like.

The touch panel 33 is a touch panel of a resistance film type or a capacitance type. The touch panel 33 is disposed on a screen of the display device 31. The touch panel 33 detects contact (touch) of a user's finger or the like on the touch panel 33 together with a contact position, and outputs a detection signal indicating coordinates of a contact position to a controller 39 of the control device 38. Consequently, it is possible to operate a GUI or the like displayed on the screen of the display device 31 via the touch panel 33.

The information processing apparatus 30 includes the physical key 32 in addition to the touch panel 33 as an operation device to which a user operation is input.

The Wi-Fi communication device 34 is a communication interface that performs Wi-Fi communication. The Wi-Fi communication device 34 transmits and receives data to and from the Wi-Fi access point 50.

The storage device 37 is a large-capacity storage device such as an SSD. The storage device 37 stores various application programs and various types of data.

The control device 38 is configured with a processor, a RAM, a ROM, and the like. The control device 38 functions as the controller 39 when a control program stored in the ROM or the storage device 37 is executed by the processor.

The controller 39 performs overall control of the information processing apparatus 30. The control device 38 is connected to the display device 31, the physical key 32, the touch panel 33, the Wi-Fi communication device 34, the storage device 37, and the like. The controller 39 controls each of the above constituents and transmits and receives a signal or data to and from each constituent.

In the image processing system Sy, the controller 19 of each image forming apparatus 10 calculates a position of the image forming apparatus 10 according to, for example, a three-point positioning method on the basis of identification information AID and a reception level of each electric wave that are transmitted from the three accessible Wi-Fi access points 50 and received by the Wi-Fi communication device 14. The controller 19 of each image forming apparatus 10 transmits apparatus state information of the image forming apparatus 10 indicating a position, a function, and a power on state or off state of the own image forming apparatus 10 to another image forming apparatus 10 from the Wi-Fi communication device 14 via the Wi-Fi access point 50, and receives apparatus state information of the other image forming apparatus 10 from the other image forming apparatus 10. Consequently, each of the plurality of image forming apparatuses 10 stores the apparatus state information of all the image forming apparatuses 10.

In the same manner as in each image forming apparatus 10, the controller 39 of the information processing apparatus 30 calculates a position of the information processing apparatus 30 according to, for example, a three-point positioning method on the basis of identification information AID and a reception level of each electric wave that are transmitted from the three accessible Wi-Fi access points 50 and received by the Wi-Fi communication device 34.

The controller 39 of the information processing apparatus 30 also causes the Wi-Fi communication device 34 to receive the apparatus state information of all of the image forming apparatuses 10 from at least one of the plurality of image forming apparatuses 10 via the Wi-Fi access point 50, and on the basis of the position of the information processing apparatus 30 and a position indicated by the apparatus state information of each of the plurality of image forming apparatuses 10, (i) arranges the respective pieces of apparatus state information of the image forming apparatuses 10 in an order of closeness to the information processing apparatus 30 to be displayed on the display device 31 or (ii) displays a map indicating the position of the information processing apparatus 30 and the position of each of the image forming apparatuses 10 on the display device 31. Consequently, a user of the information processing apparatus 30 can understand the position, the function, a power on or off state, and the like of each image forming apparatus 10. The user can also understand the position of each image forming apparatus 10 with respect to the position of the information processing apparatus 30.

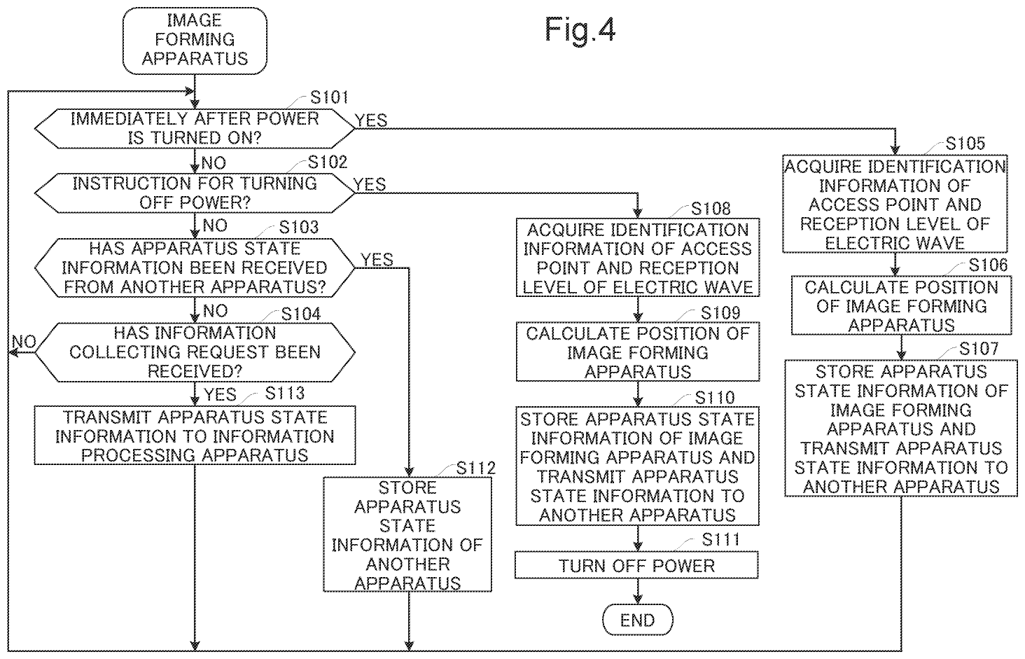

Next, a control procedure of an information sharing process of sharing the apparatus state information between the image forming apparatuses 10 will be described with reference to a flowchart of FIG. 4 and the like.

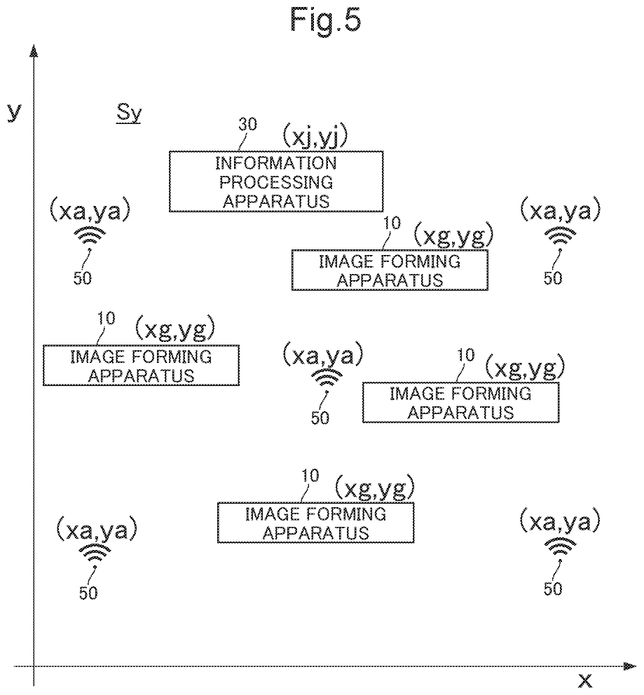

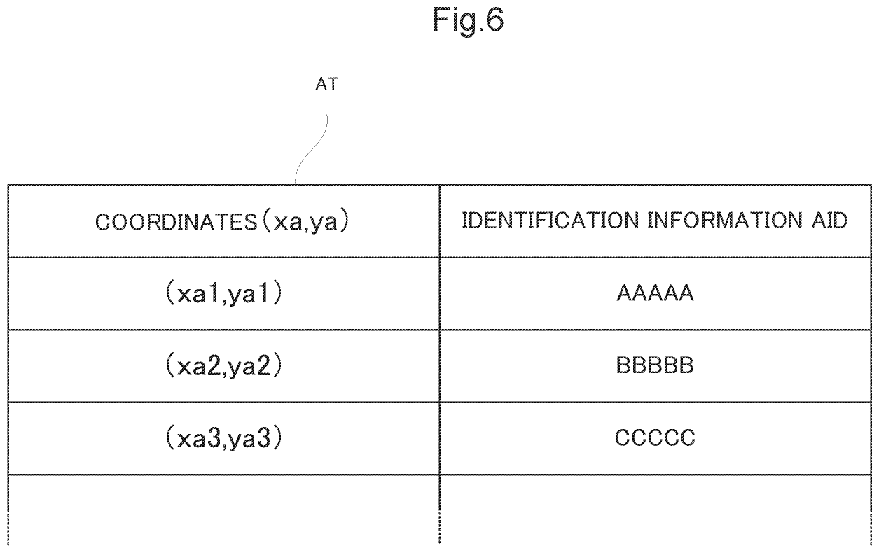

Here, the storage device 17 of each image forming apparatus 10 stores in advance a position and identification information of each Wi-Fi access point 50 in correlation with each other. For example, in an xy coordinate system shown in FIG. 5, the position of each Wi-Fi access point 50 is defined by respective coordinates (xa,ya). As shown in FIG. 6, the storage device 17 of each image forming apparatus 10 stores an access point table AT in which the coordinates (xa,ya) of each Wi-Fi access point 50 is correlated with the identification information AID of the Wi-Fi access point 50.

Each Wi-Fi access point 50 periodically transmits the identification information AID of the Wi-Fi access point 50 to each image forming apparatus 10.

The controller 19 of the image forming apparatus 10 determines whether or not power of the image forming apparatus 10 has just been turned on (step S101), determines whether or not the own image forming apparatus 10 has been instructed to turn off the power (step S102), determines whether or not the apparatus state information transmitted from another image forming apparatus 10 has been received by the Wi-Fi communication device 14 (step S103), and determines whether or not an information collecting request transmitted from the information processing apparatus 30 has been received by the Wi-Fi communication device 14 (step S104).

In a case where it is determined that the power of the own image forming apparatus 10 has just been turned on (“Yes” in step S101), the controller 19 of the image forming apparatus 10 receives the identification information AID from the Wi-Fi access point 50, and detects a reception level of the electric wave in the communication with the Wi-Fi access point 50 (step S105).

In this case, the controller 19 of the image forming apparatus 10 acquires the identification information AID from three different Wi-Fi access points 50 among the communicable Wi-Fi access points 50, and detects a reception level of the electric wave in the communication with each of the Wi-Fi access points 50. The controller 19 reads the coordinates (xa,ya) correlated with the three pieces of identification information AID from the access point table AT in the storage device 17, and calculates coordinates (xg,yg) of the own image forming apparatus 10 according to, for example, a known three-point positioning method on the basis of the coordinates (xa,ya) of the three Wi-Fi access points 50 and the reception level of electric wave with each Wi-Fi access point 50 (step S106).

The controller 19 refers to the date and time measured by a timer built in the control device 18, and acquires the calculation date and time ST when the coordinates (xg,yg) of the own image forming apparatus 10 are calculated. The controller 19 stores apparatus state information including the coordinates (xg,yg) of the own image forming apparatus 10, identification information GID of the own image forming apparatus 10, the function of the own image forming apparatus 10, and a power on state of the own image forming apparatus 10, and the calculation date and time ST of the coordinates (xg,yg) of the own image forming apparatus 10 in the storage device 17, and transmits the apparatus state information from the Wi-Fi communication device 14 to all other image forming apparatuses 10 via the Wi-Fi access points 50 (step S107). Thereafter, the controller 19 returns to the process in step S101.

The apparatus state information is received by all the other image forming apparatuses 10 (only the apparatuses in the power on state) and stored in the storage devices 17 of all the other image forming apparatuses 10. The apparatus state information may be transmitted from another image forming apparatus 10 to still another image forming apparatus 10 and stored in the storage device 17 of still another image forming apparatus 10. By repeating such transmission and reception and storage, the apparatus state information of all the image forming apparatuses 10 is stored in the storage device 17 of each image forming apparatus 10.

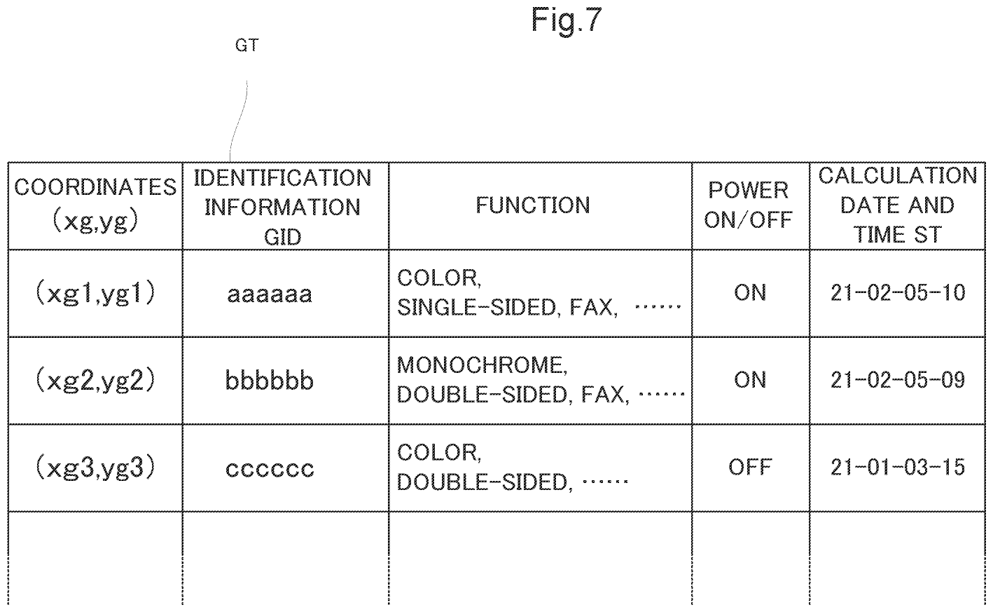

For example, the storage device 17 of each image forming apparatus 10 stores a device table GT shown in FIG. 7. In the device table GT, the coordinates (xg,yg), the identification information GID, the function, and the power on/off state of each image forming apparatus 10, and the calculation date and time ST of the coordinates (xg,yg) are written in correlation with each other. The function of each image forming apparatus 10 is, for example, monochrome or color, single-sided or double-sided, or FAX. The respective image forming apparatuses 10 have the same functions as or different functions from each other.

In a case where it is determined that the own image forming apparatus 10 has been instructed to turn off the power (“Yes” in step S102), in the same manner as in the processes in steps S105 to S107, the controller 19 of the image forming apparatus 10 acquires the identification information AID of the three Wi-Fi access points 50, also acquires a reception level of the electric wave from each Wi-Fi access point 50 (step S108), and calculates the coordinates (xg,yg) of the own image forming apparatus 10 according to, for example, a three-point positioning method on the basis of the coordinates (xa,ya) of the three Wi-Fi access points 50 and the reception level of electric wave with each Wi-Fi access point 50 (step S109). The controller 19 refers to the date and time measured by the timer built in the control device 18, and acquires the calculation date and time ST when the coordinates (xg,yg) of the own image forming apparatus 10 are calculated. The controller 19 writes the coordinates (xg,yg), the identification information GID, the function, and a power off state of the own image forming apparatus 10, and the calculation date and time ST of the coordinates (xg,yg) as apparatus state information into the device table GT in the storage device 17, and transmits the apparatus state information from the Wi-Fi communication device 14 to all other image forming apparatuses 10 via the Wi-Fi access points 50 (step S110). After the process in step S110, the controller 19 switches the power of the own image forming apparatus 10 from an on state to an off state (step S111). Consequently, the image forming apparatus 10 stops its operation.

The apparatus state information is received by another image forming apparatus 10 and written into the device table GT in the storage device 17 of the other image forming apparatus 10. The other image forming apparatus 10 may transmit the apparatus state information to still another image forming apparatus 10. In this case, the apparatus state information is written into the device table GT in the storage device 17 of still another image forming apparatus 10.

By repeating such transmission and reception and storage, the apparatus state information of all the image forming apparatuses 10 is stored in the storage device 17 of each image forming apparatus 10.

In a case where the apparatus state information transmitted from another image forming apparatus 10 has been received by the Wi-Fi communication device 14 (“Yes” in step S103), the controller 19 of the image forming apparatus 10 writes the apparatus state information of the other image forming apparatus 10 into the device table GT in the storage device 17 (step S112). The controller 19 may transmit the apparatus state information transmitted from the other image forming apparatus 10 from the Wi-Fi communication device 14 to still another image forming apparatus 10 via the Wi-Fi access point 50. After the process in step S112, the controller 19 returns to the process in step S101.

As described above, in each image forming apparatus 10, the coordinates (xg,yg) of the image forming apparatus 10 are calculated immediately after the power of the image forming apparatus 10 is turned on and when the image forming apparatus 10 is instructed to turn off the power, and the coordinates (xg,yg), the identification information GID, the function, and a power on or off state of the image forming apparatus 10, and the calculation date and time ST are written in the device table GT in the storage device 17 as the apparatus state information, and the apparatus state information is transmitted to other image forming apparatuses 10. Consequently, the device table GT in the storage device 17 of each image forming apparatus 10 is updated one by one, and thus the apparatus state information indicating the coordinates (xg,yg), the identification information GID, the function, and the power on or off state of each image forming apparatus 10, and the calculation date and time ST is shared with the image forming apparatuses 10.

In a case where the information collecting request transmitted from the information processing apparatus 30 has been received by the Wi-Fi communication device 14 (“Yes” in step S104), the controller 19 of the image forming apparatus 10 reads the apparatus state information of each image forming apparatus 10 from the device table GT in the storage device 17, and transmits the apparatus state information of the own apparatus and the apparatus state information of the other image forming apparatuses 10 from the Wi-Fi communication device 14 to the information processing apparatus 30 via the Wi-Fi access point 50 (step S113). After the process in step S113, the controller 19 returns to the process in step S101.

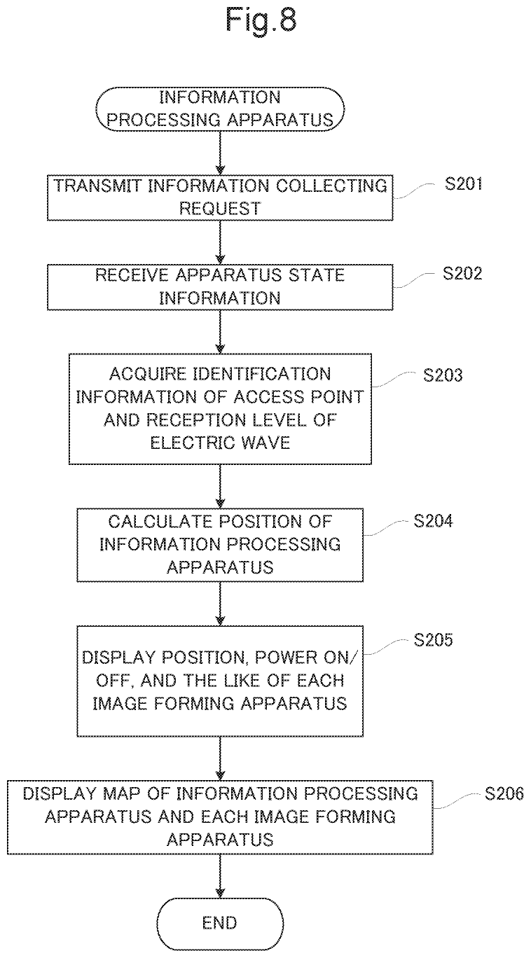

Next, with reference to a flowchart of FIG. 8 and the like, a control procedure of a state display process for displaying a position (coordinates), a power on or off state, and the like of each image forming apparatus 10 on the display device 31 of the information processing apparatus 30 will be described.

In the information processing apparatus 30, when a user operates a GUI or the like displayed on the display device 31 via the touch panel 33 and inputs an instruction for a request for collecting information of each image forming apparatus 10, the controller 39 transmits an information collecting request to each image forming apparatus 10 from the Wi-Fi communication device 34 via the Wi-Fi access point 50 in response to the instruction (step S201).

When the information collecting request is received by the Wi-Fi communication device 14 in each image forming apparatus 10 (“Yes” in step S104), the controller 19 reads the apparatus state information of each image forming apparatus 10 including the own image forming apparatus 10 from the device table GT in the storage device 17 as described above, and transmits the apparatus state information of each image forming apparatus 10 including the own image forming apparatus 10 to the information processing apparatus 30 from the Wi-Fi communication device 14 via the Wi-Fi access point 50 (step S113).

The Wi-Fi communication device 34 of the information processing apparatus 30 receives the apparatus state information of each image forming apparatus 10 including the own image forming apparatus 10, which is transmitted from each image forming apparatus 10 (step S202).

The storage device 17 of the information processing apparatus 30 stores the access point table AT shown in FIG. 6. The controller 39 of the information processing apparatus 30 acquires the identification information AID from the three accessible Wi-Fi access points 50, and detects a reception level of each electric wave in the communication with the three Wi-Fi access points 50 (step S203). The controller 39 reads the coordinates (xa,ya) respectively correlated with the three pieces of identification information AID from the access point table AT in the storage device 37, and calculates coordinates (xj,yj) of the information processing apparatus 30 on the basis of the coordinates (xa,ya) of the three Wi-Fi access points 50 and the reception level of the electric wave with each Wi-Fi access point 50 according to, for example, a three-point positioning method (step S204).

The controller 39 of the information processing apparatus 30 calculates a separation distance between the information processing apparatus 30 and each image forming apparatus 10 on the basis of the coordinates (xj,yj) of the information processing apparatus 30 and the coordinates (xg,yg) of each image forming apparatus 10 indicated by the apparatus state information in the device table GT. The controller 39 sequentially selects each image forming apparatus 10 in an order of the shorter separation distance, that is, sequentially selects each image forming apparatus 10 in an order of closeness to the information processing apparatus 30, and arranges the coordinates (xg,yg), the identification information GID, the function, and a power on or off state of each image forming apparatus 10 in the selected order to be displayed on the screen of the display device 31 on the basis of the apparatus state information (step S205).

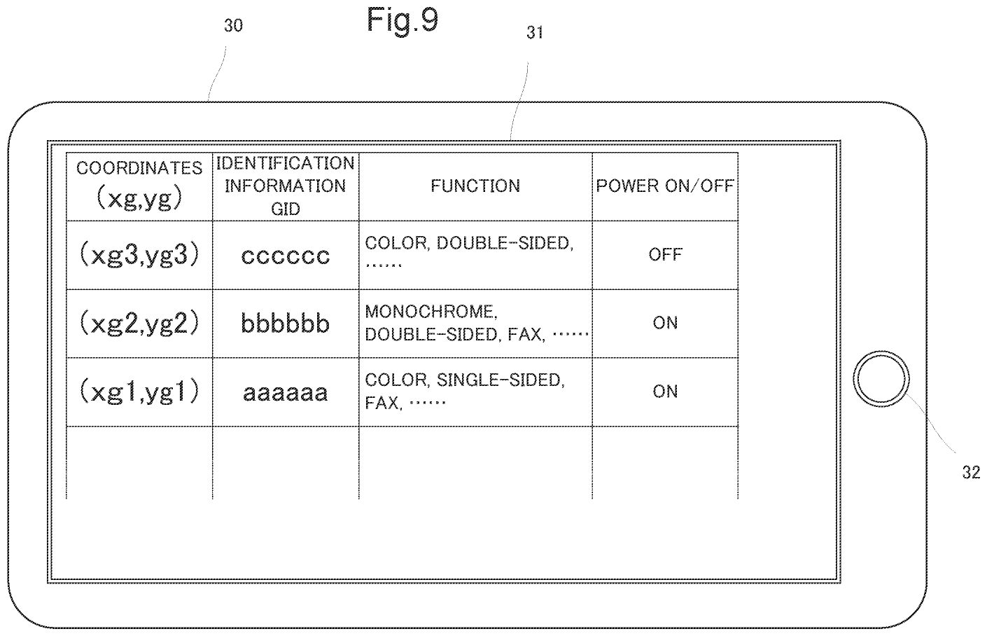

For example, as shown in FIG. 9, the controller 39 of the information processing apparatus 30 arranges the coordinates (xg,yg), the identification information ID, the function, and the power on or off state of each image forming apparatus 10 in an order of closeness to the information processing apparatus 30 to be displayed on the screen of the display device 31.

When the user operates the GUI or the like displayed on the display device 31 via the touch panel 33 and inputs an instruction for displaying a map for each image forming apparatus 10, the controller 39 of the information processing apparatus 30 generates a map indicating a positional relationship between the information processing apparatus 30 and each image forming apparatus 10 on the basis of the coordinates (xj,yj) of the information processing apparatus 30 and the coordinates (xg,yg) of each image forming apparatus 10 in the device table GT in response to the instruction, and displays the map on the screen of the display device 31 (step S206).

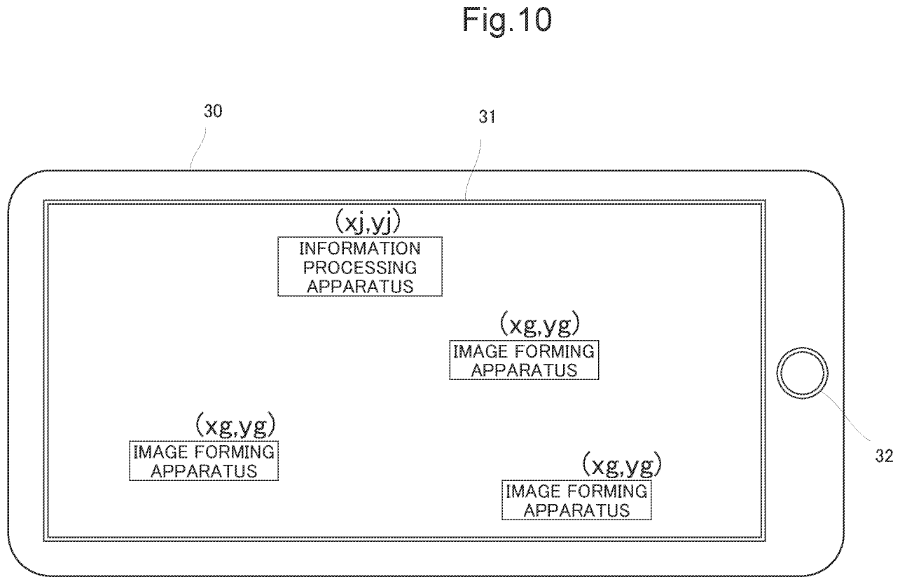

For example, as shown in FIG. 10, the controller 39 of the information processing apparatus 30 displays a map MP indicating the positional relationship between the information processing apparatus 30 and each image forming apparatus 10 on the screen of the display device 31.

Consequently, a user of the information processing apparatus 30 can understand which of the plurality of image forming apparatus 10 is near the information processing apparatus 30. The user can also select the image forming apparatus 10 having a necessary function and quickly go to a position of the selected image forming apparatus 10. Even if the power of the image forming apparatus 10 is turned off, the apparatus state information of the image forming apparatus 10 of which the power is turned off is also displayed on the screen of the display device 31, and thus the user can also recognize the image forming apparatus 10 of which the power is turned off as the image forming apparatus 10 capable of performing printing when the power is turned on. Consequently, the user can use the image forming apparatus 10 by going to the image forming apparatus 10 of which the power is turned off and switching the power of the image forming apparatus 10 from an off state to an on state.

Incidentally, in the above general first technique, the operation information indicating an operation state of a printer is managed, but the operation information is information indicating in service or out of service of the printer, and is not information indicating power on or off of the printer. In the second technique, device information is collected from a device terminal apparatus in operation.

That is, in both the first technique and the second technique, a position of the printer or device terminal apparatus of which power is turned on is acquired, and a printer or a device terminal apparatus is selected on the basis of the acquired position.

Therefore, in a case where power of a printer or a device terminal apparatus closest to a user is turned off, the printer or the device terminal apparatus is not detected, or information indicating the printer or device terminal apparatus is not displayed, and a printer or a device terminal apparatus farther than the printer or device terminal apparatus is detected or displayed. As a result, the detection or display may not always be optimal for the user.

On the other hand, according to the first embodiment, the respective image forming apparatuses 10 transmit and receive the apparatus state information including the coordinates (xg,yg), the identification information ID, the function, and a power on or off state of each image forming apparatus 10, and the calculation date and time ST to and from each other via the Wi-Fi communication devices 14 and share the apparatus state information. The controller 39 of the information processing apparatus 30 receives the apparatus state information of each image forming apparatus 10 from at least one of the plurality of image forming apparatuses 10 via the Wi-Fi communication device 34, and preferentially and sequentially arranges the coordinates (xg,yg), the identification information ID, the function, the power on or off state, and the like of each image forming apparatus 10 in an order of the image forming apparatus 10 closer to a position of the information processing apparatus 30 to be displayed on the screen of the display device 31. Therefore, in an environment in which a plurality of image forming apparatuses 10 are installed, a user of the information processing apparatus 30 can accurately detect all the image forming apparatuses 10 regardless of the power on or off state of the image forming apparatuses. As a result, the user can select the optimum image forming apparatus 10 regardless of the power on or off state of the image forming apparatus 10, quickly go to a position of the selected image forming apparatus 10, and use the image forming apparatus 10.

If the controller 39 of the information processing apparatus 30 can receive the apparatus state information of each image forming apparatus 10 from at least one image forming apparatus 10 among all the image forming apparatuses 10, the controller 39 can update the device table GT by storing the apparatus state information of the image forming apparatus 10. This is because each image forming apparatus 10 stores the apparatus state information thereof and other image forming apparatuses 10, and can thus transmit the apparatus state information to the information processing apparatus 30.

The image processing system Sy enables the respective image forming apparatuses 10 to share apparatus state information with each other without requiring a server.

### Second Embodiment

Hereinafter, an image processing system of a second embodiment will be described. The image processing system of the second embodiment has the configurations shown in FIGS. 1 to 3 as in the image processing system Sy of the first embodiment.

In the first embodiment, the controller 19 of the image forming apparatus 10 calculates the coordinates (xg,yg) and the like of the own image forming apparatus 10 immediately after the power of the image forming apparatus 10 is turned on and when an instruction for turning off the power is given, and updates the own apparatus state information in the device table GT. On the other hand, in the second embodiment, the controller 19 calculates the coordinates (xg,yg) and the like of the own image forming apparatus 10 every preset certain time, and updates the own apparatus state information in the device table GT. The controller 19 shares the own apparatus state information with the other image forming apparatus 10 by transmitting the updated own apparatus state information to other image forming apparatuses 10.

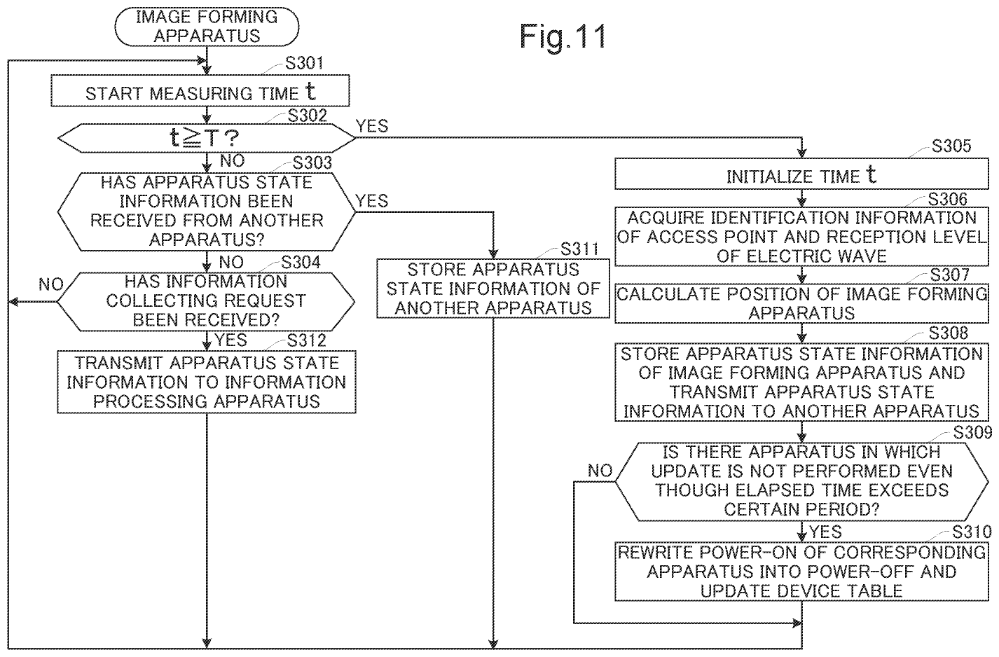

Next, in the second embodiment, with reference to a flowchart of FIG. 11 and the like, a control procedure of an information sharing process of sharing a position and a power on or off state of each image forming apparatus 10 between the image forming apparatuses 10 will be described.

The controller 19 of the image forming apparatus 10 starts measuring a time t (step S301), and determines whether or not the time t has reached a preset certain time (for example, 12 hours) T (step S302). If the time t does not reach the certain time T (“No” in step S302), the controller 19 of the image forming apparatus 10 determines whether or not the apparatus state information transmitted from another image forming apparatus 10 has been received by the Wi-Fi communication device 14 (step S303), and determines whether or not an information collecting request transmitted from the information processing apparatus 30 has been received by the Wi-Fi communication device 14 (step S304).

For example, in a case where it is determined that the apparatus state information of another image forming apparatus 10 has not been received by the Wi-Fi communication device 14 (“No” in step S303), an information collecting request has not been received by the Wi-Fi communication device 14 (“No” in step S304), and the time t has reached the certain time T (“Yes” in step S302), the controller 19 of the image forming apparatus 10 initializes the time t (step S305), acquires the identification information AID of the three different Wi-Fi access points 50, and detects a reception level of the electric wave in the communication with each Wi-Fi access point 50 (step S306).

The controller 19 of the image forming apparatus 10 reads the coordinates (xa,ya) respectively correlated with the three pieces of identification information AID from the access point table AT in the storage device 17, and calculates coordinates (xg,yg) of the own image forming apparatus 10 according to, for example, a known three-point positioning method on the basis of the coordinates (xa,ya) of the three Wi-Fi access points 50 and the reception level of a beacon with each Wi-Fi access point 50 (step S307).

The controller 19 refers to the date and time measured by the timer built in the control device 18, and acquires the calculation date and time ST when the coordinates (xg,yg) of the own image forming apparatus 10 are calculated. The controller 19 of the image forming apparatus 10 also writes the coordinates (xg,yg), the identification information GID, the function, and a power off state of the own image forming apparatus 10, and the calculation date and time ST as apparatus state information into the device table GT in the storage device 17, and transmits the apparatus state information from the Wi-Fi communication device 14 to all other image forming apparatuses 10 via the Wi-Fi access points 50 (step S308).

The apparatus state information of the own image forming apparatus 10 is received by another image forming apparatus 10 and written into the device table GT in the storage device 17 of the other image forming apparatus 10. The apparatus state information may be transmitted from the other image forming apparatus 10 to still another image forming apparatus 10 and written into the device table GT in the storage device 17 of still another image forming apparatus 10. By repeating such transmission and reception and storage, the coordinates (xg,yg), the identification information GID, the function, and the power on or off state of the own image forming apparatus 10, and the calculation date and time ST are written in the device table GT in the storage device 17 of each image forming apparatus 10. Consequently, the coordinates (xg,yg), the identification information GID, the function, and the power on or off state of each image forming apparatus 10, and the calculation date and time ST are shared between the plurality of image forming apparatus 10.

Subsequently, the controller 19 of the image forming apparatus 10 refers to the device table GT in the storage device 17, reads the calculation date and time ST of the coordinates (xg,yg) of each image forming apparatus 10, calculates an elapsed time Δt from the calculation date and time ST for each calculation date and time ST by referring to the date and time measured by the timer built in the control device 18, and determines whether or not the elapsed time Δt exceeds a preset certain time T (step S309).

In a case where it is determined that the elapsed time Δt from the calculation date and time ST exceeds the certain time T (“Yes” in step S309), the controller 19 of the image forming apparatus 10 rewrites a power on state correlated with the calculation date and time ST in the device table GT into a power off state to update the device table GT (step S310). In a case where it is determined that the elapsed time Δt from the calculation date and time ST does not exceed the certain time T for any calculation date and time ST (“No” in step S309), the controller 19 of the image forming apparatus 10 returns to the process in step S301 without performing the process in S310.

Here, in any of the plurality of image forming apparatus 10, when the time t has reached the certain time T (“Yes” in step S302), the controller 19 calculates the coordinates (xg,yg) of the own image forming apparatus 10 (step S307), writes the coordinates (xg,yg), the identification information GID, the function, and a power on state of the own image forming apparatus 10, and the calculation date and time ST as apparatus state information into the device table GT in the storage device 17, and transmits the apparatus state information from the Wi-Fi communication device 14 to other image forming apparatuses 10 (step S308).

As described above, the apparatus state information of all the image forming apparatuses 10 is written in the device table GT in the storage device 17 of each image forming apparatus 10 and shared between the image forming apparatuses 10. Therefore, the calculation date and time ST of the coordinates (xg,yg) of each image forming apparatus 10 is updated every certain time T. Thus, in a case where the elapsed time Δt from the calculation date and time ST exceeds the certain time T, this indicates that the image forming apparatus 10 in which the calculation date and time ST is not updated every certain time T, that is, the elapsed time Δt from the calculation date and time ST exceeds the certain time T is stopped, and the power of the image forming apparatus 10 is turned off.

Therefore, if there is the image forming apparatus 10 in which the elapsed time Δt from the calculation date and time ST exceeds the certain time T (“Yes” in step S309), the controller 19 of the image forming apparatus 10 regards that the power of the image forming apparatus 10 in which the elapsed time Δt exceeds the certain time T is turned off, and rewrites a power on state correlated with the identification information AID of the image forming apparatus 10 into a power off state in the device table GT (step S310).

On the other hand, in a case where the apparatus state information transmitted from another image forming apparatus 10 has been received by the Wi-Fi communication device 14 (“Yes” in step S303), the controller 19 of the image forming apparatus 10 writes the coordinates (xg,yg), the identification information GID, the function, and the power on or off state of the other image forming apparatus 10, and the calculation date and time ST indicated by the apparatus state information into the device table GT in the storage device 17, and transmits the apparatus state information of the other image forming apparatus 10 from the Wi-Fi communication device 14 to still another image forming apparatus 10 via the Wi-Fi access point 50 (step S311). Thereafter, the controller 19 returns to the process in step S301.

In a case where the information collecting request transmitted from the information processing apparatus 30 has been received by the Wi-Fi communication device 14 (“Yes” in step S304), the controller 19 of the image forming apparatus 10 reads the apparatus state information from the device table GT in the storage device 17, and transmits the apparatus state information of the own apparatus and the apparatus state information of the other image forming apparatuses 10 from the Wi-Fi communication device 14 to the information processing apparatus 30 via the Wi-Fi access point 50 (step S312). Thereafter, the controller 19 returns to the process in step S301.

In the same manner as in the first embodiment, in the information processing apparatus 30, the control procedure in the flowchart of FIG. 8 is executed to preferentially and sequentially arrange the coordinates (xg,yg), the identification information ID, the function, and the power on or off state of each image forming apparatus 10 in an order of the image forming apparatus 10 closer to a position of the information processing apparatus 30 to be displayed on the screen of the display device 31, generates a map indicating a positional relationship between the information processing apparatus 30 and each image forming apparatus 10, and displays the map on the screen of the display device 31.

As described above, according to the second embodiment, when the time t has reached the certain time T, the controller 19 of each image forming apparatus 10 calculates the coordinates (xg,yg) of the own image forming apparatus 10, writes the coordinates (xg,yg), the identification information GID, the function, and the power on state of the own image forming apparatus 10, and the calculation date and time ST into the device table GT as apparatus state information, and transmits the apparatus state information to another image forming apparatus 10. Consequently, the apparatus state information of each image forming apparatus 10 is updated and shared every certain time T between the image forming apparatuses 10.

In a case where there is the image forming apparatus 10 in which the elapsed time Δt from the calculation date and time ST exceeds the certain time T, the controller 19 of each image forming apparatus 10 rewrites a power on state indicated by the device table GT of the image forming apparatus 10 into a power off state. Consequently, a power on or off state near to an actual state of each image forming apparatus 10 is accurately stored in the device table GT.

Modification example of second embodiment A modification example of the second embodiment will be described. As described above, the storage device 17 of each image forming apparatus 10 stores the device table GT indicating the calculation date and time ST indicating the date and time when the coordinates (xg,yg) of each image forming apparatus 10 are calculated. In the present modification example, the controller 19 of each image forming apparatus 10 calculates an elapsed date and time Δtt from the calculation date and time ST on the basis of the current date and time measured by the timer built in the control device 18 and the calculation date and time ST in the device table GT, and in a case where the elapsed date and time Δtt has reached a preset certain period (for example, one month), deletes the calculation date and time ST and the apparatus state information of the image forming apparatus 10 corresponding to the calculation date and time ST from the device table GT. Consequently, the image forming apparatus 10 of which the coordinates (xg,yg) and the like have not been updated while the power has been turned off for a long time can be omitted from the device table GT.

In a case where the elapsed date and time Δtt from the calculation date and time ST has reached the certain period for the image forming apparatus 10 of which apparatus state information indicates that the power is off, the controller 19 of each image forming apparatus 10 may delete the apparatus state information of the image forming apparatus 10 from the device table GT.

### Other Modification Examples

In the first and second embodiments, the controllers 19 and 39 calculate the coordinates (xg,yg) of the image forming apparatus 10 and the coordinates (xj,yj) of the information processing apparatus 30 on the basis of the coordinates (xa,ya) of the three Wi-Fi access points 50 and a reception level of the electric wave with each Wi-Fi access point 50 according to a three-positioning method, but a position of the image forming apparatus 10 and a position of the information processing apparatus 30 may be measured according to other methods. For example, a GPS receiver is provided in each of the image forming apparatus 10 and the information processing apparatus 30, and the controllers 19 and 39 measure a position of each image forming apparatus 10 and a position of the information processing apparatus 30 by the GPS receivers. In this case, since the Wi-Fi access point is not required to specify a position, data communication between the image forming apparatuses 10 and data communication between the information processing apparatus 30 and each image forming apparatus 10 may be performed according to another communication method.

A position of each image forming apparatus 10 may be measured in advance and stored in each storage device 17, and the information processing apparatus 30 may be provided with a GPS receiver, and the controller 39 may measure a position of the information processing apparatus 30 with the GPS receiver. In this case, since the Wi-Fi access point is not required to specify a position, data communication between the image forming apparatuses 10 and data communication between the information processing apparatus 30 and each image forming apparatus 10 may be performed according to another communication method.

In the above embodiments, a multi-function peripheral is used as the image forming apparatus according to the present disclosure, but this is only an example, and another image forming apparatus such as a copier, a printer, or a facsimile apparatus may be used.

The configurations and processes of the first and second embodiments described with reference to FIGS. 1 to 11 are merely embodiments of the present disclosure, and the present disclosure is not intended to be limited to the configurations and processes.

While the present disclosure has been described in detail with reference to the embodiments thereof, it would be apparent to those skilled in the art the various changes and modifications may be made therein within the scope defined by the appended claims.

What is claimed is:

1. An image processing system comprising:
a plurality of image forming apparatuses that perform data communication with each other; and
an information processing apparatus that performs data communication with each of the plurality of image forming apparatuses, wherein
each of the plurality of image forming apparatuses includes
a storage device,
a first communication device that performs data communication with the other image forming apparatus other than an own image forming apparatus among the plurality of image forming apparatuses and the information processing apparatus via a network, and
a first control device that includes a processor, and, by the processor executing a control program, functions as a first controller that transmits first apparatus state information indicating a position, a function, and a power on state or off state of the own image forming apparatus to the other image forming apparatus via the first communication device, and when second apparatus state information indicating a position, a function, and a power on state or off state of the other image forming apparatus is received from the other image forming apparatus via the first communication device, stores the second apparatus state information in the storage device,
the information processing apparatus includes
a display device,
a second communication device that performs data communication with each of the plurality of image forming apparatuses via the network, and
a second control device that includes a processor and, by the processor executing a control program, functions as a second controller that transmits an information collecting request to at least one of the plurality of image forming apparatuses via the second communication device,
when the information collecting request is received via the first communication device, the first controller of the image forming apparatus transmits the first apparatus state information and the second apparatus state information read from the storage device to the information processing apparatus via the first communication device, and
when the first apparatus state information and the second apparatus state information are received via the second communication device, the second controller of the information processing apparatus displays the positions, the functions, and the power on states or off states of the own image forming apparatus and the other image forming apparatus indicated by the first apparatus state information and the second apparatus state information on the display device.

2. The image processing system according to claim 1, wherein
the first controller of the image forming apparatus transmits the first apparatus state information to the other image forming apparatus via the first communication device when power of the own image forming apparatus is turned on or off.

3. The image processing system according to claim 1, wherein
in a case where an elapsed time from when the first communication device last received the second apparatus state information exceeds a predefined period, the first controller of the image forming apparatus changes the power on state indicated by the second apparatus state information to the power off state.

4. The image processing system according to claim 1, wherein
the first controller of the image forming apparatus deletes the second apparatus state information from the storage device when the power off state indicated by the second apparatus state information has continued for a certain period.

5. The image processing system according to claim 1, wherein
the first communication device of the image forming apparatus performs the data communication via each of a plurality of Wi-Fi points,
the first controller of the image forming apparatus calculates the position of the own image forming apparatus on the basis of a position of each of the plurality of Wi-Fi points and a level of reception of an electric wave by the first communication device in communication with at least three Wi-Fi points among the plurality of Wi-Fi points,
the second communication device of the information processing apparatus performs the data communication via each of the plurality of Wi-Fi points, and
the second controller of the information processing apparatus calculates a position of the information processing apparatus on the basis of the position of each of the plurality of Wi-Fi points and a level of reception of an electric wave by the second communication device in communication with at least three Wi-Fi points among the plurality of Wi-Fi points.

6. The image processing system according to claim 1, wherein
the second controller of the information processing apparatus arranges pieces of apparatus state information of the plurality of image forming apparatuses in an order of closeness to the information processing apparatus to be displayed on the display device on the basis of a position of the information processing apparatus and the position indicated by the apparatus state information of each of the plurality of image forming apparatuses.

7. The image processing system according to claim 1, wherein
the second controller of the information processing apparatus generates a map indicating a position of the information processing apparatus and the position of each of the plurality of image forming apparatuses on the basis of the position of the information processing apparatus and the position indicated by apparatus state information of each of the plurality of image forming apparatuses, and displays the generated map on the display device.

8. The image processing system according to claim 1, wherein
in a case where an elapsed time from when the first communication device last received the second apparatus state information exceeds a predefined period, the first controller of the image forming apparatus deletes the second apparatus state information from the storage device.
